(19) United States
(12) Patent Application Publication
(10) Pub. No.: US 2003/0151168 A1
(43) Pub. Date: Aug. 14, 2003

(54) Method and apparatus for molding an article having a textile covering layer

(75) Inventors: Terrence G. Gohl, Dearborn Heights, MI (US); Stephen J. Hawkins, Madisonville, KY (US); Timothy C. Heslet, Nebo, KY (US); John T. Kuykendall, Clay, KY (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: Lear Corporation, Southfield, MI

(21) Appl. No.: 10/122,536

(22) Filed: Apr. 15, 2002

Related U.S. Application Data
(60) Provisional application No. 60/355,580, filed on Feb. 8, 2002.

(51) Int. Cl. B29C 49/20

(52) U.S. Cl. 264/516; 264/257; 425/117; 425/522; 264/523

(57) ABSTRACT

A method and apparatus for molding a textile covered part in a plastic molding machine. A textile segment such as a piece of carpet is sprayed with a water mist prior to being loaded into the plastic molding machine. In a blow molding operation, a blow molding parison is loaded into the mold and expanded with compressed air to form the textile covered part. The machine includes a blow molding machine and a spray applicator that sprays water onto the textile segment prior to being loaded into the blow molding machine.

### CROSS-REFERENCE TO RELATED APPLICATIONS

This application claims the benefit of U.S. provisional application Serial No. 60/355,580 filed Feb. 8, 2002.

### BACKGROUND OF THE INVENTION

1. Field of the Invention

The present invention relates to a plastic molding process wherein a carpet or fabric covered plastic article is molded.

2. Background Art

Plastic interior parts such as floor panel sections for vehicles are molded from glass filled polypropylene plastic in a blow molding operation. Such parts may provide a structural, substantially rigid article that is formed to a desired shape and bonded to a piece of carpet. Cycle times for the manufacture of these pieces are relatively long. Due to the long cycle times, many molds and molding machines must be used to manufacture such parts in high production volumes. Long cycle times add to tooling costs due to the number of tools required and increase direct labor costs of the process.

One example of a prior art method of making an interior trim piece with a covering layer is disclosed in U.S. Pat. No. 6,183,038. According to this patent, a coolant such as water is sprayed through nozzles onto the back side of a cavity of a mold to cool a carrier. Once the carrier is cooled, the method includes the step of opening the mold and removing the carrier from the mold. The door trim substrate is attached to the carrier by fastener adhesives, heat staking, sonic welding or the like. While this method uses water to cool the back side of the mold, it does not disclose a simple and effective method of manufacturing a carpet covered molded article.

These and other problems and disadvantages inherent in the prior art process are addressed by applicants' invention and summarized below.

### SUMMARY OF THE INVENTION

According to the present invention, a method of molding a plastic part having a textile covering layer in a blow molding machine defining a mold cavity is disclosed. The textile covering layer may be a piece of carpet having pile on one side, a textured polypropylene mat or other fabric. The textile segment is sprayed with a water mist that is then loaded into the mold with a heated blow molding parison. The mold is closed and the parison is expanded with compressed air within the mold to press against the mold cavity and the textile layer, thereby forming a textile covered part having a desired shape. The textile covered part is removed from the mold and may be trimmed to remove flash.

According to another aspect of the invention, the textile is attached to a mold loading fixture prior to spraying with the water mist.

According to another aspect of the invention, a machine for blow molding a carpet covered article is provided. The machine includes a blow molding machine having a mold for forming a plastic part to a desired shape. A loading fixture supports a textile segment such as a section of carpet having pile on one side. A spray applicator sprays a water mist on the side of the textile segment before it is loaded into the mold. A blow molding parison and the dampened textile segment are placed in the mold of the blow molding machine. The blow molding machine is closed while the blow molding parison is expanded by compressed air to fill the mold, thereby forming the plastic part with the textile segment on one side. Heat transfer through the textile segment is facilitated by the mist of water that has been applied to the textile segment.

These and other aspects of the present invention will be better understood in view of the attached drawings and following detailed description.

### BRIEF DESCRIPTION OF THE DRAWINGS

FIG. 1 is a perspective view of a blow molding machine having a mold for blow molding a textile covered part and also having a water mist spray applicator that sprays a textile segment with water prior to being loaded into the blow molding machine;

FIG. 2 is a side elevation view of the blow molding machine showing the water mist applicator spraying water on a textile segment;

FIG. 3 is a side elevation view of the textile segment and blow molding parison disposed in the mold prior to closing the mold;

FIG. 4 is a cross-sectional view showing the textile covered part in the mold after the textile covered part is formed.

### DETAILED DESCRIPTION OF THE PREFERRED EMBODIMENTS

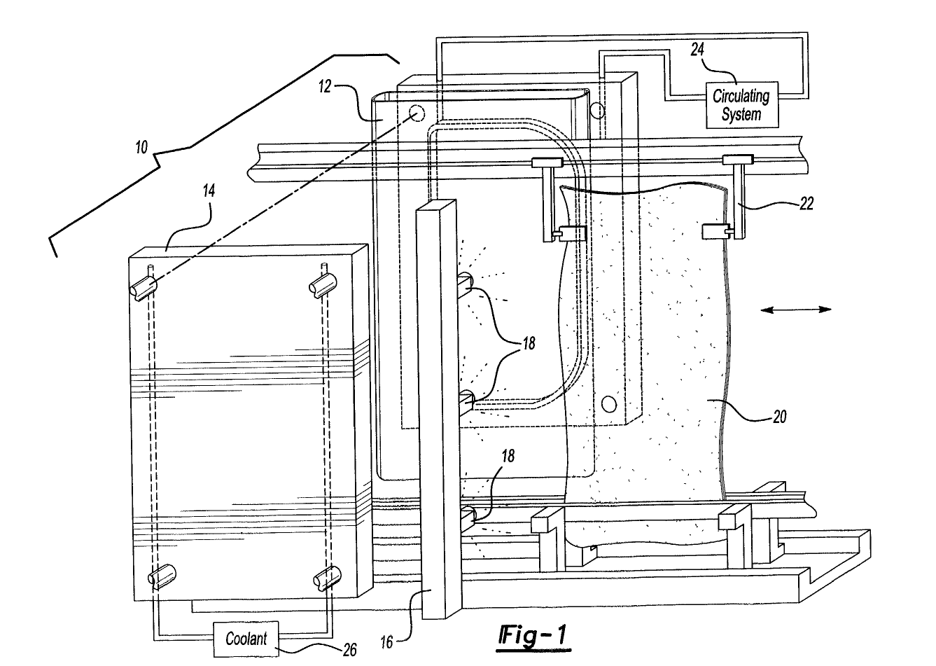

Referring now to FIG. 1, a molding machine 10 is shown with first and second mold members 12, 14. The molding machine illustrated is a blow molding machine, however, it should be understood that the present invention may be applicable to injection molding machines or other plastic molding machines that are used to form a plastic part having a textile segment on at least one portion thereof. A water mist spray fixture 16 has a plurality of nozzles 18 for directing a mist of water on a textile segment 20 that is referred to hereinafter as a carpet section 20. The carpet section 20 is held by a loading fixture 22. The water mist spray fixture 16 sprays the carpet section 20 while it is held in the loading fixture 22 prior to being loaded into the molding machine 10. The molding machine has a temperature control fluid circulating system 24 for controlling the temperature of the first mold member 12 to, for example, 160° F. The molding machine 10 is provided with a coolant system 26 that has a circulating coolant medium that is used to cool the second mold member 14.

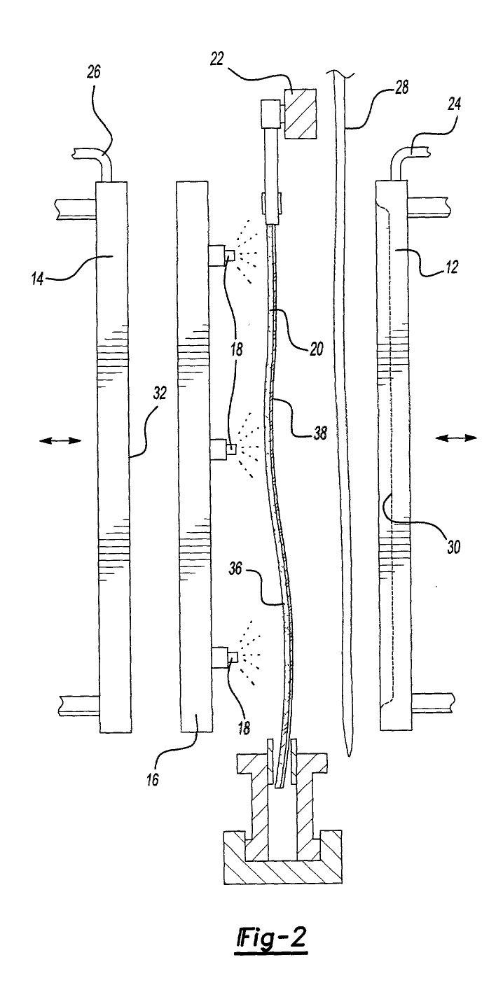

Referring now to FIG. 2, the textile segment shown is a carpet section 20 is shown as the water mist spray fixture 16 sprays water through the nozzles 18 while the carpet section 20 is retained by the loading fixture 22. A parison 28 comprising a molten mass of plastic, for example 30% glass-filled polypropylene, as it is dropped out of a head (not shown) into the cavity defined by the first and second mold members 12, 14. The parison 28 is preferably heated to an elevated temperature, such as 400° F., and is inserted between the carpet section 20 and the mold cavity 30 of the first mold member 12. A mold surface 32 of the second mold member 14 contacts the carpet section 20.

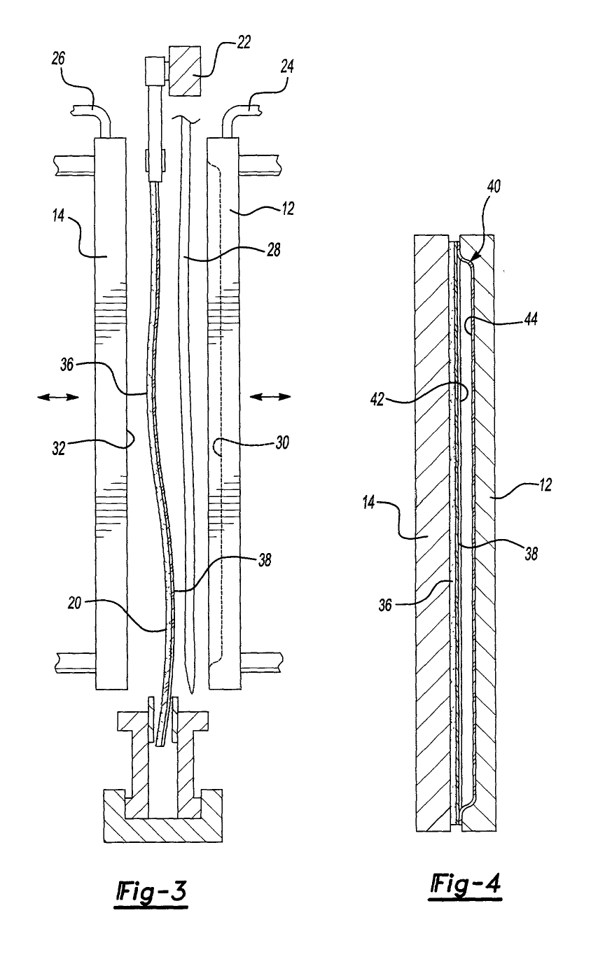

Referring now to FIG. 3, the first and second mold members 12, 14 are shown just before closing with the carpet section 20 and parison 28 being retained in the mold adjacent the mold surface 32 and the mold cavity 30, respectively. The carpet section 20 has a carpet pile portion 36 that is sprayed with the water mist and is placed in contact with the mold surface 32. Carpet backing 38 faces the parison 28. The parison 28 is molded to the carpet backing 38 during the molding process.

Referring now to FIG. 4, the first and second mold members 12, 14 are shown with the mold cavity closed and containing the carpet section 20 with a blow molded body 40 being formed to fill the mold. In a blow molding operation, the parison 28 is filled with compressed air (for example 110 psi) that inflates the parison 28 and fills the mold cavity 30 forcing the carpet section 20 against the mold surface 32. The blow molded body 40, after forming, has a carpet covered surface 42 and a back surface 44 that conform to the shape of the mold cavity 30. The coolant system 26 cools the first and second mold members 12, 14 until the blow molded body 40 is substantially rigid.

The blow molding operation will be described below, however, it should be understood that the steps of the blow molding operation may be performed in different sequences. In the blow molding operation, the carpet section 20 (or other textile segment) is initially placed on the automatic loading fixture 22 and water mist is sprayed on the carpet pile 36 prior to being loaded into the molding machine 10. A parison 28 of molten plastic drops out of a head section of the molding machine 10. The loading fixture 22 transfers the carpet section 20 to locating pins in the mold that hold the carpet in the proper position within the mold during the molding process. The mold closes and air is blown into the parison 28 inflating the parison. Water deposited on the carpet pile 36 facilitates heat transfer through the carpet and promotes cooling of the blow molded body 40. The carpet may be polyester spun carpet, woven carpet, textured polypropylene mat, cloth, or the like depending on the desired covering material of the finished part. The carpet pile is compressed as the parison inflates and is driven into contact with the mold surface 32. The mold is primarily cooled by the circulating coolant water. The cooling process is also facilitated by the water in the carpet pile since the heat from the parison heats the water in the carpet pile and may be emitted from the mold as steam through the mold vents. After the molding process, most of the water that was sprayed on the carpet pile is either evaporated or converted to steam. The insulating effect of the carpet covered surface 42 of the blow molded body 40 is minimized because the water in the carpet pile 36 provides a heat transfer medium.

After the blow molded body 40 is formed, it is unloaded by means of the loading fixture 22 from the mold and may be trimmed to remove any flash formed during the blow molding process. The part may be trimmed by conventional knives or cutters or may be cut by means of a water jet knife to remove flash from the part.

The blow molded body 40 may be used in a variety of applications where a load bearing hollow member that includes a carpeted surface is required. For example, the process may be used to make flipper panels for vehicle floors or lids for cargo storage compartments in vehicles.

While the application has been described principally with reference to a blow molding operation, it is also possible that the water mist spray fixture 16 could be used in conjunction with an injection molding process or vacuum forming process. The invention may be applied to such processes if a part is made in a plastic molding machine wherein molten plastic is molded to a section of carpet and then cooled in the mold to form a finished part.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of molding a textile covered part comprising:
providing a blow molding machine having a mold;
loading a heated blow molding parison into the mold;
providing a textile segment;
spraying the textile segment with a water mist to create a dampened textile segment;
loading the dampened textile segment into the mold;
blowing air into the parison to expand the parison within the mold and against the dampened textile segment to form a textile covered part having the desired shape; and
removing the textile covered part from the mold.

2. The method of claim 1 further comprising the step of attaching the textile segment to a mold loading fixture before the spraying step.

3. The method of claim 1 wherein the textile segment is a piece of carpet having a pile formed on one side thereof.

4. The method of claim 3 wherein the step of spraying the textile segment further comprises spraying the pile of the piece of carpet.

5. A method of molding a covered part comprising:
providing a covering material having pile on one side thereof;
spraying the pile of the covering material with a water mist;
loading the covering material into a mold;
feeding a molten plastic material into the mold;
applying pressure to the molten plastic material in the mold and forcing the covering material into contact with the side of the mold to form a covered part having a desired shape; and
removing the covered part from the mold.

6. A machine for blow molding a carpet covered article comprising:
a blow molding machine having a mold for forming a plastic part to a desired shape;
a loading fixture for supporting a textile segment;
a spray applicator for spraying a water mist on one side of the textile segment before the textile segment is loaded into the mold; and
wherein a blow molding parison and the textile segment after being sprayed with water are placed in the mold of the blow molding machine that is closed while the blow molding parison is expanded by compressed air to fill the mold thereby forming the plastic part with the textile segment on one side and wherein heat transfer through the section of carpet is facilitated by the water on the textile segment.

7. The machine of claim 6 wherein the textile segment is a piece of carpet.

8. The machine of claim 7 wherein the piece of carpet has a pile formed on one side thereof and wherein the spray applicator is oriented to spray the water mist on the pile.
